(19) United States
(12) Patent Application Publication
(10) Pub. No.: US 2026/0159112 A1
(43) Pub. Date: Jun. 11, 2026

(54) ALERT CONTROL DEVICE AND METHOD FOR A VEHICLE

(71) Applicant: TOYOTA JIDOSHA KABUSHIKI KAISHA, Toyota-shi (JP)

(72) Inventor: Kotaro SAIKI, Toyota-shi (JP)

(73) Assignee: TOYOTA JIDOSHA KABUSHIKI KAISHA, Toyota-shi (JP)

(21) Appl. No.: 19/181,526

(22) Filed: Apr. 17, 2025

(30) Foreign Application Priority Data
Apr. 25, 2024 (JP) 2024-071028

(51) Int. Cl. B60W 50/14; B60W 30/095; B60W 30/18

(52) U.S. Cl. CPC B60W 50/14; B60W 30/0956; B60W 30/18159; B60W 2050/143; B60W 2520/10; B60W 2540/18; B60W 2554/4046

(57) ABSTRACT

A vehicle alert control device includes an electronic control unit activates an alarm device to issue a warning when the electronic control unit determines that there is a possibility of a collision between a moving object moving in an oncoming lane and the own vehicle when the own vehicle is about to change direction across the oncoming lane at an intersection, and activates the alarm device, in which the electronic control unit determines that there is a possibility of a collision when it is determined that the moving object and the own vehicle are approaching each other based on behavior of them, and an index value indicating a degree of approach between the moving object and the own vehicle is determined to be greater than a reference value in a situation in which the electronic control unit has determined that the own vehicle is executing a change of direction.

### CROSS-REFERENCE TO RELATED APPLICATION

This application claims priority to Japanese Patent Application No. JP 2024-071028 filed on Apr. 25, 2024, the content of which is hereby incorporated by reference in its entirety into this application.

### BACKGROUND

### 1. Technical Field

The present invention relates to a driving assistance device and methods for a vehicle such as an automobile, and more specifically to an alert control device and method that alert a driver when a vehicle is turning at an intersection.

### 2. Description of the Related Art

As one type of driving assistance device for a vehicle such as automobiles, a collision prevention assistance device is known that is configured to first issue a warning and then further decelerate the vehicle by automatic braking when there is a risk of collision with an obstacle.

For example, in the Japanese Patent Application Laid-open Publication No. 2023-023824, a collision prevention assistance control device is described that is configured to issue a warning at a timing earlier than automatic braking when it is judged that there is a risk of collision between a moving object moving in an oncoming lane and an own vehicle when the own vehicle is attempting to change direction by crossing over the oncoming lane at an intersection.

According to this type of collision prevention assistance device, when an own vehicle is about to change direction at an intersection, crossing over an oncoming lane, and there is a risk of collision between the moving object moving in the oncoming lane and the own vehicle, an alarm is issued to alert a driver and assist in collision prevention.

### SUMMARY OF THE INVENTION

In a conventional collision prevention assistance device such as the collision prevention assistance device described in the above Publication, in order to prevent an unnecessary issuance of warnings, one of the conditions for issuing a warning is that a vehicle speed when changing direction at an intersection is above a reference vehicle speed.

Therefore, even if there is a risk of collision between the vehicle and a moving object moving in the opposite lane, if the vehicle speed is below the standard speed, it is not possible to issue a warning, and there is a risk that collision prevention support will not be provided.

### SUMMARY

The present disclosure provides an improved alert control device and method that reduces a risk of an alert not being issued when an own vehicle is about to change direction across an oncoming lane at an intersection, despite a risk of a collision between a moving object moving in the oncoming lane and the own vehicle.

According to the present disclosure, an alert control device for a vehicle is provided that includes a surrounding information acquisition device that acquires information around an own vehicle, an alarm device, and an electronic control unit that controls the alarm device, wherein the electronic control unit is configured to determine, based on information acquired by the surrounding information acquisition device, when the own vehicle is about to change direction across an oncoming lane at an intersection, that there is a possibility of collision between the own vehicle and a moving object moving in the oncoming lane, and activate the alarm device to issue an alarm.

The electronic control unit is configured to determine that there is a possibility of collision between the moving object and the own vehicle when the electronic control unit determines that an index value indicating a degree of approach between the moving object and the own vehicle, which is calculated based on behavior of the moving object and the own vehicle, is greater than or equal to a reference value in a situation where the electronic control unit determines that the own vehicle is executing a change of direction.

According to the present disclosure, an alert control method is provided that includes steps of: determining whether or not there is a possibility of a collision between a moving object moving in an oncoming lane and an own vehicle when the own vehicle is attempting to change direction across the opposing lane at an intersection, based on information about the surroundings of the own vehicle acquired by a surrounding information acquisition device; and activating an alarm device to issue an alarm when it is determined that there is a possibility of a collision.

The alert control method further includes a step of determining whether or not an index value indicating a degree of approach between the moving object and the own vehicle, which is calculated based on behavior of the moving object and the own vehicle, is equal to or greater than a reference value in a situation where it is determined that the own vehicle is executing the said change of direction, and a step of determining that there is a possibility of collision between the moving object and the own vehicle when the index value is determined to be equal to or greater than the reference value.

According to the above-mentioned alert control device and method, when it is judged that the own vehicle is executing a change of direction at an intersection, an index value indicating the degree of approach between the moving object and the own vehicle is calculated based on the behavior of the moving object and the own vehicle. Furthermore, when it is judged that the index value is equal to or greater than the standard value, it is determined that there is a possibility of a collision between the moving object and the own vehicle, and a warning is issued.

Therefore, even if the vehicle speed of the own vehicle is low when changing direction at an intersection, as long as it is determined that the own vehicle is in the process of changing direction, a warning can be issued in situations where there is a possibility of a collision between the own vehicle and a moving object in the opposite lane. Therefore, compared to the conventional method, the risk of a warning not being issued can be reduced.

In one aspect of the present disclosure, the electronic control unit stores a standard speed in a lateral direction to an own lane when the own vehicle executes a change of direction at the intersection, and is configured to calculate an estimated travel time required for the own vehicle to move from the own lane to a waiting position for the change of direction from a time point of start of the change of direction based on a distance in a lateral direction from the own lane to the turn waiting position, and to determine that the own vehicle is executing the change of direction when duration time of a situation in which a vehicle speed of the own vehicle exceeds a reference vehicle speed is equal to or longer than a reference duration time during a period from the start of the change of direction to the elapse of the said estimated travel time.

In another aspect of the present disclosure, the electronic control unit is configured to determine that the own vehicle has started the change of direction when the vehicle speed of the own vehicle is higher than a reference value and a steering angle is higher than a reference steering angle in a direction of the change of direction, in a situation where the own vehicle is in an area of the intersection and blinkers are operating in a mode of the change of direction.

In another aspect of the present disclosure, the electronic control unit is configured to estimate a first time required for the moving object to move to a side of the waiting position for the change of direction based on the information acquired by the surrounding information acquisition device, to estimate a second time required for the own vehicle to move to the waiting position for the change of direction, and to determine that the index value is greater than or equal to the reference value when a difference between the first time and the second time that is the index value is greater than or equal to a lower limit reference difference and less than or equal to an upper limit reference difference,.

In this application, “turning across the oncoming lane” is “turning right” in countries where vehicles drive on the left, and “turning left” in countries where vehicles drive on the right. “Waiting position for turning” is “waiting position for turning right” (a position to stop temporarily when turning right) in countries where vehicles drive on the left, and “waiting position for turning left” (a position to stop temporarily when turning left) in countries where vehicles drive on the right. The “own lane” is the lane in which the vehicle is traveling before changing direction at an intersection. The “opposite lane” is the lane in which the moving object is moving in the opposite direction to the own vehicle, and in countries where vehicles drive on the left, it is located to the right of the own lane, and in countries where vehicles drive on the right, it is located to the left of the own lane.

Other objects, other features and attendant advantages of the present disclosure will be readily understood from the description of the embodiments of the present disclosure described with reference to the following drawings.

### BRIEF DESCRIPTION OF THE DRAWINGS

FIG. 1 is a schematic diagram showing an alert control device for a vehicle according to n embodiment.

FIG. 2 is a flowchart corresponding to an alert control program in the embodiment.

FIG. 3 is a diagram showing a situation in which an own vehicle is turning right at an intersection.

FIG. 4 is a diagram showing a vehicle speed when the own vehicle is turning right at an intersection.

FIG. 5 shows an example in which the own vehicle starts from a stopped state and turns right, and the vehicle speed increases beyond the reference value Vc while turning right.

FIG. 6 shows a modified example in which a possibility of a collision with an oncoming moving object is determined when the own vehicle turns right at an intersection.

### DETAILED DESCRIPTION

An embodiment of the vehicle alert control device and method according to the present invention, which is configured for countries where vehicles drive on the left, will now be described in detail with reference to the accompanying drawings.

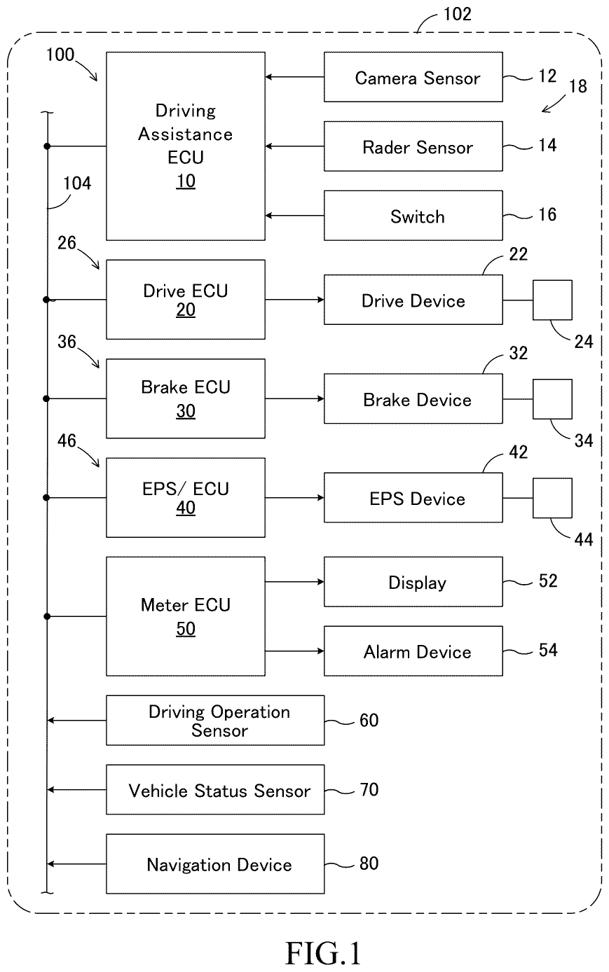

As shown in FIG. 1, an alert control device 100 of the present invention is applied to a vehicle 102 and includes a driving assistance ECU 10. The vehicle 102 is a vehicle capable of automatic driving, and is equipped with a drive ECU 20, a brake ECU 30, an EPS ECU 40, and a meter ECU 50. The term “ECU” refers to an electronic control unit that is mainly composed of a microcomputer. The vehicle 102 is denoted as “own vehicle 102” as necessary to distinguish it from other vehicles.

The microcomputer of each ECU includes a CPU, ROM, RAM, a read/write non-volatile memory (N/M), and an interface (I/F), etc. The CPU realizes various functions by executing the instructions (programs, routines) stored in the ROM. Furthermore, these ECUs are connected to each other in a way that enables data exchange (communication) via a Controller Area Network (CAN) 104. Therefore, the detected values of sensors (including switches) connected to a specific ECU are also transmitted to other ECUs.

The driving assistance ECU 10 is a central control device that performs driving support control, such as alert control, collision prevention assistance control, and adaptive distance control. In the present application, the collision prevention assistance control is referred to as PCS control, which is an abbreviation for Pre-crash Safty.

When the driving assistance ECU 10 determines that there is a possibility of a collision between the moving object moving in the opposite lane and the own vehicle when the own vehicle is about to turn right across the opposite lane at an intersection, it executes a warning control that activates an alert device and issues a warning to a driver. Furthermore, when the driving assistance ECU 10 determines that there is a risk of collision between a control object, such as another vehicle, and the own vehicle, it executes the PCS control that performs risk reduction control that reduces the risk. In the risk reduction control, an alarm is issued to the driver by activating the alert device, and the risk of collision between the control object and the own vehicle is reduced by deceleration by braking and/or automatic steering as necessary.

The driving assistance ECU 10 is connected to a camera sensor 12, a radar sensor 14, and a setting device 16. The camera sensor 12 and the radar sensor 14 include multiple camera devices and multiple radar devices, respectively. The camera sensor 12 and the radar sensor 14 function as target information acquisition devices 18 that acquire target information on objects in a vicinity of the vehicle 102.

Each camera device of the camera sensor 12, which is not shown in the FIG. 1, is provided with a camera section that takes pictures of surroundings of the vehicle 102 and a recognition section that analyzes the image data obtained by the camera section to recognize objects such as white lines of a road and other vehicles. The recognition section supplies information on the recognized objects to the driving assistance ECU 10 at predetermined time intervals.

Each radar device of the radar sensor 14 uses millimeter wave band radio waves to detect a distance between the own vehicle and a solid object, a relative speed between the own vehicle and the solid object, and a relative position (direction) of the solid object with respect to the own vehicle, and supplies information representing these to the driving assistance ECU 10 at predetermined time intervals. In addition, LiDAR (Light Detection And Ranging) may be used in place of or in addition to the radar sensor 14.

A setting device 16 is provided in a position that can be operated by the driver, such as a steering wheel, which is not shown in FIG. 1, and is operated by the driver. Although not shown in FIG. 1, the setting device 16 includes a driving assistance switch. The driving assistance ECU 10 executes driving control for driving assistance when the driving assistance switch is turned on.

The drive ECU 20 is connected to a drive device 22 that accelerates the vehicle 102 by applying driving force to drive wheels 24. The drive ECU 20 controls the drive device 22 so that the driving force generated by the drive device 22 changes in accordance with driving operation by the driver in normal operation, and when it receives a command signal from the driving assistance ECU 10, it controls the drive device 22 based on the command signal. Therefore, the drive ECU 20 and the drive device 22 cooperate to function as a driving control device 26.

The brake ECU 30 is connected to a brake device 32 that decelerates the vehicle 102 by applying braking force to wheels 34. Under normal conditions, the brake ECU 30 controls the brake device 32 so that the braking force generated by the brake device varies in accordance with braking operation performed by the driver. When it receives a command signal from the driving assistance ECU 10, it performs automatic braking by controlling the brake device 32 based on the command signal.

Therefore, the brake ECU 30 and the brake device 32 cooperate to function as a braking control device 36. In addition, when braking force is applied to the wheels by driving control, etc., brake lights, which are not shown in FIG. 1, are turned on.

The EPS/ECU 40 is connected to an EPS device 42. The EPS/ECU 40 controls a steering assist torque and reduces a burden on the driver by controlling the EPS device 42 based on a steering torque and a vehicle speed, in a manner known in the art. The EPS/ECU 40 can also actuate a steering wheel 44 to steer as necessary by controlling the EPS device 42. Therefore, the EPS/ECU 40 and EPS device 42 cooperate to function as an automatic steering device 46.

The meter ECU 50 is connected to a display 52 that displays status of the control by the driving assistance ECU 10, etc., and an alarm device 54 that issues alerts or warnings. The display 52 may be a multi-information display that displays meters and various types of information, or it may be the display of a navigation device 80 described below. As described below, when the display 52 receives a signal from the driving assistance ECU 10, it displays status of driving assistance control.

The alarm device 54 is activated when it is determined that there is a risk of the vehicle 102 colliding with a control object such as another vehicle, and it issues a warning as one of the risk reduction controls to reduce the risk of collision, that is, it issues a warning to the effect that there is a risk of the vehicle 102 colliding with a control object. The alarm device 54 may be any of a visual warning device that emits visual warnings such as warning lamps, an auditory warning device that emits auditory warnings such as warning buzzers, or a haptic warning device that emits haptic warnings such as seat vibrations, or any combination thereof. Furthermore, the warning device 54 is also activated when it is determined that there is a possibility of a collision between the moving object moving in an oncoming lane and the own vehicle when the own vehicle is about to turn right across the oncoming lane at an intersection, and it functions as a warning device that emits a warning. An alert is less persuasive to the driver than an alarm.

Driving operation sensors 60 and vehicle status sensors 70 are also connected to the CAN 104. Information detected by the driving operation sensors 60 and the vehicle status sensors 70 (referred to as sensor information) is transmitted to the CAN 104. The sensor information transmitted to the CAN 104 can be used as appropriate in each ECU. The sensor information is information from a sensor connected to a specific ECU, and it may be transmitted from that specific ECU to CAN 104.

The driving operation sensors 60 includes a driving operation amount sensor, a braking operation amount sensor, a brake switch, and a turn signal switch. The driving operation sensors 60 also includes a steering angle sensor that detects a steering angle θ and a steering torque sensor. The steering angle sensor detects a steering angle with the steering angle in the right turning direction of the vehicle as positive. The vehicle state sensors 70 includes a vehicle speed sensor that detects a vehicle speed V, a longitudinal acceleration sensor, a lateral acceleration sensor, and a yaw rate sensor.

In addition, a navigation device 80 is also connected to the CAN 104. The navigation device 80 is equipped with a GPS receiver that detects a position of the vehicle 102, a memory device that stores map information and road information, and a communication device that acquires the latest information on map information and road information from an external source. In particular, the road information includes intersection information, and includes information on classification of roads as specified in Road Structure Ordinance.

The target information acquisition device 18 and the navigation device 80 function as a surrounding information acquisition device that acquires information around the vehicle. In addition, an external communication device may function as part of the surrounding information acquisition device, and the road information may be acquired by external communication.

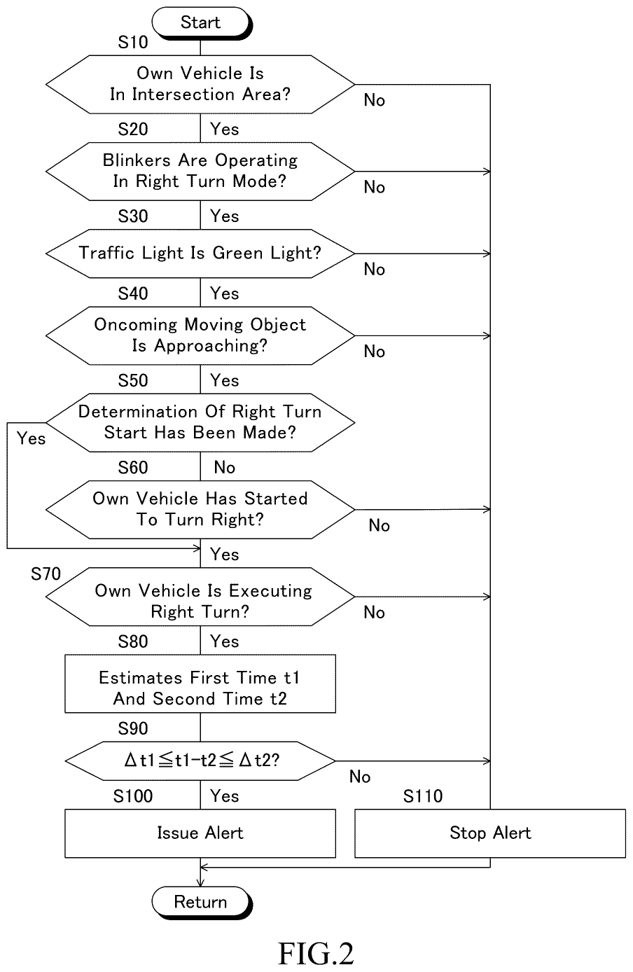

In the embodiment, the ROM of the driving assistance ECU 10 stores an alert control program corresponding to the flowchart shown in FIG. 2. The alert control program in the embodiment is a program for executing alert control in countries where vehicles drive on the left.

In addition, the ROM of the driving assistance ECU 10 stores the relationship between the classification of roads specified in the Road Structure Ordinance and a total Lrof a width Lc of a central dividing strip and a width Ls of a side strip and a width Lo of a lane. Furthermore, the ROM of the driving assistance ECU 10 stores an average vehicle speed Vta when a general vehicle turns right, and a standard lateral speed Vty (average vehicle movement speed in a direction perpendicular to the vehicle's own lane) when a vehicle turns right.

### Alert Control (FIG. 2)

Next, the alert control in the embodiment will be explained with reference to the flowchart shown in FIG. 2. The alert control according to the flowchart shown in FIG. 2 is repeatedly executed at predetermined intervals by the CPU of the driving assistance ECU 10 in a situation where the driving assistance switch is turned on. The alert control method in the embodiment is executed by executing the alert control according to the flowchart shown in FIG. 2.

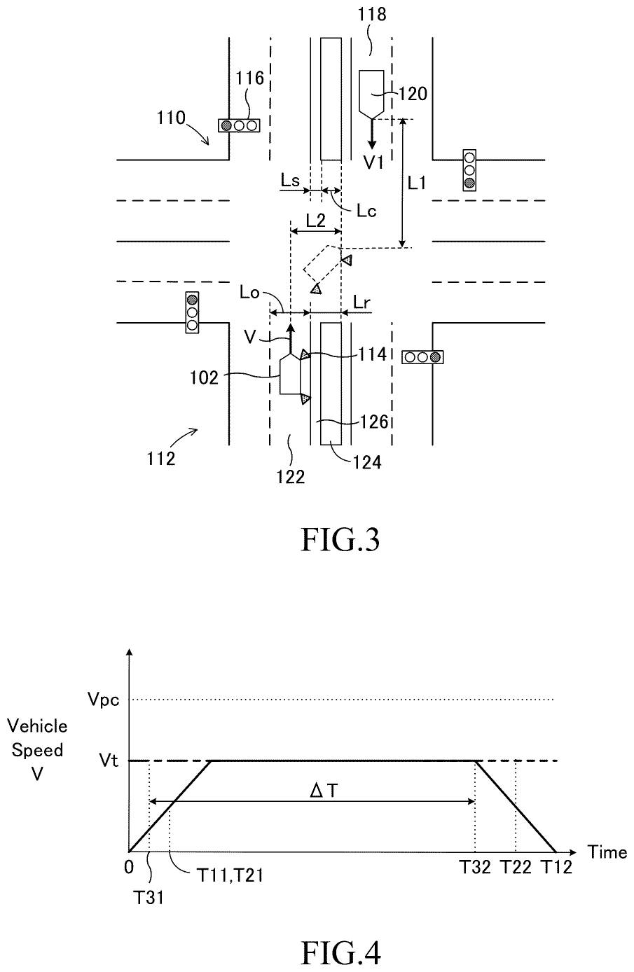

First, in step S10, the CPU determines whether or not the own vehicle 102 is in an area 112 (intersection and surrounding area) of an intersection 110, based on information around the vehicle acquired by the surrounding information acquisition device, as shown in FIG. 3. When a negative determination is made, the control proceeds to step S110, and when an affirmative determination is made, the control proceeds to step S20.

In step S20, the CPU determines whether or not blinkers 114 are operating in right turn mode based on a status of a blinker switch of the driving operation sensor 60. When a negative determination is made, the control proceeds to step S110, and when an affirmative determination is made, the control proceeds to step S30.

In step S30, the CPU determines whether or not a traffic light 116 in front of the vehicle 102 at the intersection 110 is a green light. When a negative determination is made, the control proceeds to step S110, and when an affirmative determination is made, the control proceeds to step S40.

In step S40, the CPU determines whether or not an oncoming moving object 120, such as an oncoming vehicle traveling in an oncoming lane 118 on the right side of the own vehicle 102, is approaching the own vehicle. When a negative determination is made, the control proceeds to step S110, and when an affirmative determination is made, the control proceeds to step S50.

In step S50, the CPU determines whether or not determination of a right turn start timing T1 has already been made, i.e., whether or not it has already been determined that the own vehicle 102 has started to turn right. When an affirmative determination is made, the control proceeds to step S70, and when a negative determination is made, the control proceeds to step S60.

In step S60, the CPU determines whether or not the own vehicle 102 has started to turn right by determining whether or not the vehicle speed V is higher than a reference value Vo (0 or a positive constant) and the steering angle θ is greater than or equal to a reference value θc (a positive constant). When a negative determination is made, the control proceeds to step S110, and when an affirmative determination is made, it is determined that the right turn has started, and the present point in time is determined to be the right turn start timing T1, and the control proceeds to step S70.

In step S70, the CPU determines whether or not the own vehicle 102 is executing a right turn. When a negative determination is made, the control proceeds to step S110, and when an affirmative determination is made, the control proceeds to step S80.

In this connection, whether or not the own vehicle 102 is executing a right turn may be determined by following steps a to D, for example. In FIG. 3, the positions of the own vehicle 102 indicated by the solid and dashed lines are a position at the start of the right turn and a position at the right turn standby, respectively.
A. First, the information on the road classification acquired by the navigation device 80 is acquired.
B. Based on the road classification, a width Lo of an own lane, i.e., a width Lo of a lane in which the own vehicle 102 is traveling before the right turn, and a total width Lr of a median strip 124 and a side strip 126, as shown in FIG. 3, are identified.
C. A time ΔT required to move to a right turn waiting position after it is determined that the own vehicle 102 has started to turn right is calculated according to the following formula (1), for example. The following formula (1) is a formula for calculating a time required for a central portion of a leading edge of the own vehicle 102, which is a reference position, to move from a center of the own lane to a position corresponding to a boundary of the median strip 124 on the side of the oncoming vehicle 120. Notably, it is assumed that when the own vehicle is traveling along its own lane 122, it is determined that the vehicle has started to turn right.

$$Δ T = ( Lo / 2 + Lr ) / Vty \qquad ( 1 )$$

D. It is determined whether or not the vehicle speed V of the own vehicle 102 has exceeded a reference value Vc for a period of time longer than a reference duration Tce during a time from the time point T1 when the right turn is determined to have started to a time point T2 when the time ΔT has elapsed, and when an affirmative determination is made, it is determined that the own vehicle is executing a right turn.

FIG. 4 shows a vehicle speed when a general vehicle turns right at an intersection. In FIG. 4, the solid line shows a change in vehicle speed when the vehicle starts from a stopped state, turns right, and then stops at a right turn waiting position (the first case). Time point T11 is a time point when the right turn is determined to have started, and time point T12 is a time point when the vehicle reaches the right turn waiting position. The dashed line shows a change in vehicle speed when the vehicle starts from a stopped state, turns right, and then continues driving without stopping at the right turn waiting position (the second case). Time point T21 is a time point at which the vehicle starts to turn right (the same as point T11), and time point T22 is a time point at which the vehicle passes the right turn waiting position. Furthermore, the dotted line shows a change in vehicle speed when the vehicle enters the intersection while still in motion, turns right, and continues without stopping at the right turn waiting position (the third case 3). Time point T31 is a time point at which the right turn is determined to have started, and time point T32 is a timepoint at which the vehicle passes the right turn waiting position.

As shown in FIG. 4, a time from the time point at which the right turn is determined to the time point at which the vehicle reaches or passes the right turn waiting position is the shortest in the third case. Therefore, the above time ΔT is the time point from the point at which the right turn is determined to the time point at which the vehicle passes the right turn waiting position in the third case.

Furthermore, the reference value Vc may be a positive constant, in particular, a value lower than an average vehicle speed Vta when a general vehicle turns right. The reference duration Tce may be a time until a driver with general driving ability recognizes a danger and takes a deceleration action, typically, a value of about 1.5 seconds, for example.

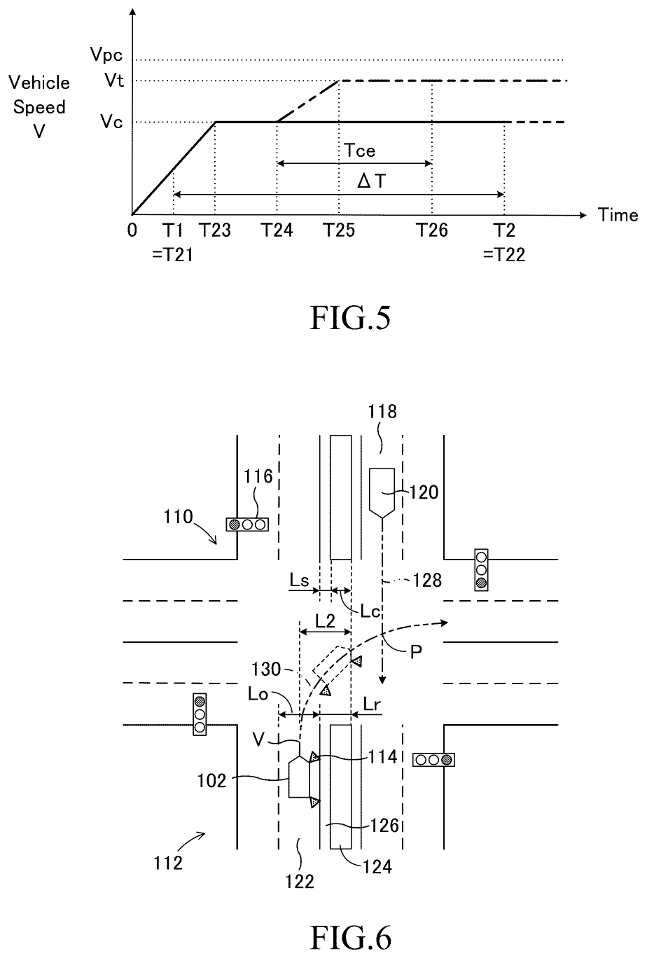

FIG. 5 shows a case where, in the second case described above, the vehicle speed V reaches the standard value Vc at time point T23, begins to increase beyond the standard value Vc at time point T24, and reaches a constant value of the standard value Vt at time point T25. If the point at which the standard duration time Tce has elapsed from time point T24 is time point T26, it is determined that the situation in which the vehicle speed V exceeds the standard value Vc has continued for a duration of at least the standard duration time Tce at time point T26, and it is determined that the own vehicle is executing a right turn.

In step S80, the CPU estimates a distance L1 between the oncoming vehicle 120 and the side of the right turn waiting position, and a vehicle speed V1 of the oncoming vehicle, based on information around the own vehicle acquired by the surrounding information acquisition device (the object information acquisition device 18 and the navigation device 80). Furthermore, the CPU estimates a first time t1 until the oncoming vehicle reaches the side of the right turn waiting position based on the distance L1 and the vehicle speed V1. In addition, the CPU estimates a lateral distance L2 (a distance in a direction perpendicular to the own lane) between a current position of the reference position of the own vehicle 102 and the reference position of the own vehicle 102 when the own vehicle 102 reaches the right turn waiting position based on the information around the own vehicle acquired by the surrounding information acquisition device. Furthermore, the CPU estimates a second time t2 until the own vehicle reaches the right turn waiting position based on the distance L2 and the standard lateral speed Vty.

In step S90, the CPU determines whether a difference t1−t2 between the first time t1 and the second time t2, which is an index value indicating a degree of approach between the oncoming vehicle 120 and the own vehicle 102, is greater than or equal to a lower limit standard difference Δt1 (a negative constant) and less than or equal to the upper limit standard difference Δt2 (a positive constant). When a negative determination is made, the control proceeds to step S110, and when an affirmative determination is made, the control proceeds to step S100.

In step S100, the CPU determines that the index value is greater than or equal to the reference value and that there is a possibility of a collision between the oncoming vehicle and the own vehicle. Furthermore, the CPU issues a warning that the own vehicle may collide with the oncoming vehicle by activating the warning device 54. In response to this, in step S110, if a warning has been issued, the CPU stops the warning and then ends the control, and if no warning has been issued, it ends the control.

In addition, when a possibility of a collision between the oncoming vehicle and the own vehicle is determined to be higher than the possibility of the collision which is determined in step S90, an alarm is issued by the PCS control, and the own vehicle may be decelerated and stopped by the automatic braking. The PCS control may be performed in any manner known in the art. For example, an alarm may be issued when the difference between the first time t1 and the second time t2, t1−t2, is greater than or equal to a lower limit Δtpa1 (a negative constant greater than Δt1) and less than or equal to an upper limit Δtpa2 (a positive constant less than Δt2). Furthermore, when the difference between the first time t1 and the second time t2, t1-t2, is greater than or equal to a lower limit Δtpb1 (a negative constant greater than Δtpa1) and less than or equal to an upper limit Δtpb2 (a positive constant less than Δtpa2), the own vehicle may be decelerated and stopped by the automatic braking.

### Operation of the Embodiment

In the embodiment, it is determined whether the own vehicle 102 is located in the area 112 of the intersection 110 (S10), and it is determined whether the turn signal 114 is operating in the right turn mode (S20). Furthermore, it is determined whether or not the traffic light 116 in front of the vehicle 102 at the intersection 110 is a green light (S30), and it is determined whether or not an oncoming moving object 120 such as an oncoming vehicle traveling in the oncoming lane 118 on the right side of the vehicle 102 is approaching the vehicle (S40).

If the above determination results in an affirmative determination, and if the vehicle speed V is higher than the reference value Vo and the steering angle θ is greater than or equal to the reference value θc, it is determined that the right turn has started (S60). When it is determined that the right turn has started, it is determined whether or not the own vehicle 102 is executing the right turn (S70). When it is determined that the own vehicle 102 is executing the right turn, the first time t1 until the oncoming moving object reaches the side of the right turn standby position and the second time t2 until the own vehicle reaches the right turn standby position are estimated (S80).

Furthermore, it is determined whether or not the difference between the first time t1 and the second time t2 (t1−t2) is greater than the lower limit reference difference Δt1 and less than the upper limit reference difference Δt2 (S90). If the difference t1−t2 is determined to be within the above range, it is determined that the index value indicating the degree of approach between the oncoming vehicle and the own vehicle is greater than or equal to the standard value, and there is a possibility of a collision between the oncoming vehicle and the own vehicle, and a warning is issued to the effect that there is a possibility of a collision between the own vehicle and the oncoming vehicle (S100).

As can be understood from the above explanation, according to the embodiment, it is determined whether or not the own vehicle 102 is executing a right turn at the intersection 110 (S70). In a situation where it is determined that the vehicle is executing a right turn, when the index value indicating the degree of approach between the oncoming vehicle and the vehicle is determined to be greater than or equal to the standard value based on the behavior of the oncoming vehicle and the vehicle, it is determined that there is a possibility of a collision between the oncoming vehicle and the vehicle, and a warning is issued (S100).

Therefore, even if the vehicle speed V of the vehicle when turning right at an intersection is low, as long as it is determined that the vehicle is executing a right turn, a warning can be issued in situations where there is a possibility of a collision between the vehicle and a moving object in the opposite lane. Therefore, compared to the past, the risk of a warning not being issued can be reduced.

In addition, according to the embodiment, the estimated travel time ΔT required for the vehicle 102 to move from the start of the right turn to the waiting position for the right turn is calculated. Furthermore, when the duration of the situation in which the vehicle speed V of the vehicle exceeds the standard vehicle speed Vc is equal to or longer than the standard duration Tce during the period from the start of the right turn to the elapse of the estimated travel time, it is judged that the vehicle is executing the right turn (S70). Since the vehicle speed of the own vehicle after it has started to turn right is determined, as shown in FIG. 5, the standard vehicle speed Vc can be lower than the standard vehicle speed Vpc, which is one of the conditions for issuing an alarm in conventional collision prevention assistance devices.

Therefore, even if the vehicle speed is lower than the standard vehicle speed of the conventional collision prevention assistance device, it is possible to determine that the vehicle is executing a right turn. In addition, in a situation where the vehicle speed of the vehicle executing a right turn is increased from a low vehicle speed, if the duration of the situation where the vehicle speed of the vehicle exceeds the standard vehicle speed Vc, which is lower than the standard vehicle speed of the conventional collision prevention assistance device, exceeds the standard duration Tce, it is determined that the vehicle is executing a right turn. Therefore, compared to the case of issuing an alert using a conventional collision prevention assistance device, it is possible to issue an alert earlier, and the risk of issuing an alert being delayed can be reduced.

In addition, according to the embodiment, when the vehicle 102 is in the intersection area 112 and the turn signal 114 is operating in the right turn mode, and the vehicle speed V of the vehicle is higher than the reference value Vo and the steering angle θ is greater than or equal to the reference steering angle θc in the right turn direction, it is determined that the vehicle has started to turn right.

Therefore, it is possible to determine that the vehicle has started to turn right more appropriately than when any of the following conditions are not determined: that the vehicle is in the intersection area, that the turn signal is operating in the right turn mode, that the vehicle speed is higher than the standard value, and that the steering angle is higher than the standard steering angle for the right turn direction.

In addition, according to the embodiment, when the difference between the first time t1 required for the oncoming moving object 120 to move to the side of the right turn standby position and the second time t2 required for the own vehicle to move to the right turn standby position is at least the lower limit standard difference Δt1 and at most the upper limit standard difference Δt2, the indicator value is determined to be at least the standard value.

Therefore, for example, the possibility of a collision between the moving object and the own vehicle can be determined appropriately, compared to when the possibility of a collision between the moving object and the own vehicle is determined based on the relative distance and relative speed between the moving object 120 moving in the direction of the oncoming lane 118 or own lane 122 and the own vehicle 102.

Furthermore, as shown in FIG. 6, the determination of the possibility of a collision may be based on the difference in time t1p and t2p until the opposing moving object and the own vehicle reach the intersection point P of the moving trajectories (modified example). However, according to the embodiment, it is not necessary to estimate the movement trajectories of the oncoming vehicle 120 and the own vehicle 102, so it is possible to determine simply whether there is a possibility of a collision between the oncoming vehicle and the own vehicle, compared to when the two movement trajectories are estimated and their intersection is determined.

Although the present disclosure has been described in detail with reference to specific embodiments, it will be apparent to those skilled in the art that the present disclosure is not limited to the above-described embodiments, and various other embodiments are possible within the scope of the present disclosure.

For example, the alert control device and method described above are configured to be used in countries where vehicles drive on the left. However, the alert control device and method of the present invention may be configured to be used in countries where vehicles drive on the right, in which case the right and left will be reversed from the embodiment.

In addition, in the above-mentioned embodiment, in addition to the alert control, the PCS control is performed, but the alert control device and method of the present invention may be applied to vehicles that do not perform the PCS control.

In the PCS control, the determination of whether there is a risk of collision between the oncoming moving object and the own vehicle may be determined based on the difference in time t1p and t2p until the oncoming moving object and the own vehicle reach the intersection point P of the two moving trajectories, where the moving trajectories of the oncoming moving object 120 and the own vehicle 102 are estimated. In this case, the lower limit reference difference Δt1 and upper limit reference difference Δt2 of the time difference t1p and t2p in the alert control are smaller and larger than the lower limit reference difference and upper limit reference difference in the PCS control, respectively

In addition, in the above-mentioned embodiment, the presence or absence of a preceding vehicle turning right at an intersection is not determined, but if it is determined that there is a preceding vehicle turning right, the control may proceed to step S110.

What is claimed is:

1. An alert control device for a vehicle that includes a surrounding information acquisition device that acquires information around an own vehicle, an alarm device, and an electronic control unit that controls the alarm device, wherein the electronic control unit is configured to determine, based on information acquired by the surrounding information acquisition device, when the own vehicle is about to change direction across an oncoming lane at an intersection, that there is a possibility of collision between the own vehicle and a moving object moving in the oncoming lane, and activate the alarm device to issue an alarm, wherein
the electronic control unit is configured to determine that there is a possibility of collision between the moving object and the own vehicle when the electronic control unit determines that an index value indicating a degree of approach between the moving object and the own vehicle, which is calculated based on behavior of the moving object and the own vehicle, is greater than or equal to a reference value in a situation where the electronic control unit determines that the own vehicle is executing a change of direction.

2. The alert control device for a vehicle according to claim 1, wherein the electronic control unit stores a standard speed in a lateral direction to an own lane when the own vehicle executes a change of direction at the intersection, and is configured to calculate an estimated travel time required for the own vehicle to move from the own lane to a waiting position for the change of direction from a time point of start of the change of direction based on a distance in a lateral direction from the own lane to the turn waiting position, and to determine that the own vehicle is executing the change of direction when duration time of a situation in which a vehicle speed of the own vehicle exceeds a reference vehicle speed is equal to or longer than a reference duration time during a period from the start of the change of direction to the elapse of the said estimated travel time.

3. The alert control device for a vehicle according to claim 2, wherein the electronic control unit is configured to determine that the own vehicle has started the change of direction when the vehicle speed of the own vehicle is higher than a reference value and a steering angle is higher than a reference steering angle in a direction of the change of direction, in a situation where the own vehicle is in an area of the intersection and blinkers are operating in a mode of the change of direction.

4. The alert control device for a vehicle according to claim 1, wherein the electronic control unit is configured to estimate a first time required for the moving object to move to a side of the waiting position for the change of direction based on the information acquired by the surrounding information acquisition device, to estimate a second time required for the own vehicle to move to the waiting position for the change of direction, and to determine that the index value is greater than or equal to the reference value when a difference between the first time and the second time that is the index value is greater than or equal to a lower limit reference difference and less than or equal to an upper limit reference difference,.

5. An alert control method for a vehicle, which includes steps of: determining whether or not there is a possibility of a collision between a moving object moving in an oncoming lane and an own vehicle when the own vehicle is attempting to change direction across the opposing lane at an intersection, based on information about the surroundings of the own vehicle acquired by a surrounding information acquisition device; and activating an alarm device to issue an alarm when it is determined that there is a possibility of a collision, wherein
the alert control method further includes a step of determining whether or not an index value indicating a degree of approach between the moving object and the own vehicle, which is calculated based on behavior of the moving object and the own vehicle, is equal to or greater than a reference value in a situation where it is determined that the own vehicle is executing the said change of direction, and a step of determining that there is a possibility of collision between the moving object and the own vehicle when the index value is determined to be equal to or greater than the reference value.
